(19) United States
(12) Patent Application Publication
(10) Pub. No.: US 2012/0149818 A1
(43) Pub. Date: Jun. 14, 2012

(54) COMPOSITION BASED ON NATURAL RUBBER AND A POLYAMINE COMPOUND

(75) Inventors: José Carlos Araujo Da Silva, Pont du Chateau (FR); Justin Belz, Riom (FR); Stéphanie De Landtsheer, Moscou (RU); Nathalie Simon, Maringues (FR)

(73) Assignees: MICHELIN RECHERCHE ET TECHNIQUE S.A., Granges-Paccot (CH); SOCIETE DE TECHNOLOGIE MICHELIN, Clermont-Ferrand (FR)

(21) Appl. No.: 13/382,107

(22) PCT Filed: Jul. 8, 2010
(86) PCT No.: PCT/EP2010/059829

§ 371 Date: Feb. 22, 2012

(30) Foreign Application Priority Data
Jul. 10, 2009 (FR) 09/03438

(51) Int. Cl. C08L 9/00; B60C 1/00

(52) U.S. Cl. 524/252

(57) ABSTRACT

Reinforced rubber composition, exhibiting improved hysteresis, based on at least (a) an elastomeric matrix predominantly based on natural rubber, (b) a reinforcing filler and (c) a specific polyamine compound present in a proportion of between 0 and 7 mmol per 100 g of elastomer.

This rubber composition is intended, for example, for the manufacture of a semi-finished rubber product intended for the tires of motor vehicles.

The present invention relates to reinforced rubber compositions based on natural rubber comprising at least one polyamine compound having improved hysteresis properties in the vulcanized state. These rubber compositions are intended, for example, for the manufacture of a semi-finished rubber product intended for the tyres of land and air vehicles.

Since savings in fuel and the need to protect the environment have become a priority, it has proved necessary to produce tyres having a rolling resistance that is as low as possible, without having a disadvantageous effect on their wear resistance. This has been made possible in particular by virtue of the use, in the rubber compositions, of specific inorganic fillers capable of competing, from a reinforcing viewpoint, with an organic filler such as conventional tyre-grade carbon black, while giving these compositions a lower hysteresis, synonymous with a lower rolling resistance for the tyres comprising them.

To further reduce the rolling resistance remains, in the current economic and ecological context, a permanent concern despite the low levels achieved respectively both with the specific inorganic fillers described as “reinforcing” and with a carbon black. Numerous avenues have already been explored in order to further lower the hysteresis of the rubber compositions reinforced with such reinforcing fillers. Mention may be made, by way of example, of the modification of the structure of the diene polymers at the end of polymerization by means of functionalization, coupling or star-branching agents, with the aim of obtaining good interaction between the polymer thus modified and the reinforcing filler. Mention may also be made of patent application WO 96/37547 A1 describing a rubber composition that uses, as reinforcing filler, carbon black with silica attached to its surface and that is based on a functionalized or unfunctionalized diene polymer and on a silane coupling or covering agent in a relatively high amount.

Patent application JP 2006/063206 A1 discloses the use of polyimines, obtained by reaction of polyamines with a compound having a carbonyl function, in order to improve the abrasion resistance of compositions based on natural or synthetic rubbers containing an inorganic filler as the sole or predominant reinforcing filler or as a blend with carbon black present in a minority amount and a silane coupling agent without significantly deteriorating the elongation and viscoelastic properties of the composition and of the tyres comprising them. In this document, no mention was made of any advantage in the use of polyamines in the field of tyres.

Hydrazides, belonging to a family similar to that of amines, are generally known for lowering the hysteresis of mixtures based on natural rubber and on carbon black as the sole or predominant reinforcing filler. In hybrid mixtures from the prior art, in particular EP 0 738 754 A1, the reduction in hysteresis losses is of the order of 13% after addition of dihydrazide compounds. Patent application FR 08/58989 A1 by the inventors also claims the use of particular dihydrazides for significantly reducing the hysteresis of rubber mixtures.

The inventors have surprisingly discovered during their research that in a rubber composition based on non-halogenated natural rubber as the main elastomer and reinforced either with an organic filler such as carbon black or with a reinforcing inorganic filler such as silica or else a blend of organic and inorganic fillers, the addition, in a small proportion, of certain primary polyamine compounds gives these vulcanized compositions improved rubber properties, in particular hysteresis properties, and especially makes it possible to significantly decrease the initial hysteresis of the composition. This significant decrease of the hysteresis in the proportions observed within the context of compositions comprising a polyamine compound is, to say the least, unexpected.

The significantly improved hysteresis properties of such compositions in accordance with the invention based on non-halogenated natural rubber and on a primary polyamine compound render the latter particularly suitable for the manufacture of semi-finished rubber products intended for tyres, especially for land motor vehicles, such as under layers, rubbers for coating metallic or textile reinforcements, sidewall rubbers or treads.

Thus, one subject of the present invention is a reinforced rubber composition based at least on an elastomeric matrix comprising non-halogenated natural rubber, on an organic or inorganic reinforcing filler or a blend of the two, on a coupling agent in the event an inorganic filler is used and on a primary polyamine compound corresponding to formula 1 or 2 below:

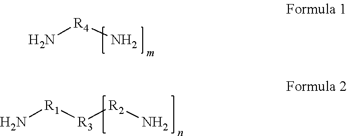

in which:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), chosen from O, N, S and Si;
m is equal to 1, 2 or 3;
n is equal to 1, 2 or 3,
   in an amount between 0 and 7 mmol per 100 g of elastomer.

Another subject of the invention is a process for the preparation of such a reinforced rubber composition defined above.

A further subject of the invention is a tyre semi-finished rubber product constituted completely or partly of the reinforced rubber composition defined above.

Another subject of the invention is a tyre comprising at least one semi-finished rubber product constituted completely or partly of the reinforced rubber composition as defined above.

For greater clarity on reading that which will follow, the expression composition “based on” is understood to mean a composition comprising the mixture and/or the reaction product of the various constituents used, some of these base constituents being capable of reacting or intended to react with one another, at least in part, during the various phases of manufacture of the composition, in particular during the crosslinking or vulcanization thereof.

In the present description, unless expressly indicated otherwise, all the percentages (%) shown are % by weight. Furthermore, any range of values denoted by the expression “between a and b” represents the field of values ranging from more than a to less than b (that is to say limits a and b excluded) whereas any range of values denoted by the expression “from a to b” means the field of values ranging from a up to b (that is to say including the strict limits a and b).

Furthermore, the amounts of the components of the invention may be expressed in phr, that is to say in parts (by weight) per hundred parts by weight of elastomer.

Thus, a first subject of the invention is a reinforced rubber composition based at least (a) on an elastomeric matrix comprising at least non-halogenated natural rubber predominantly, (b) on a reinforcing filler, (c) on a primary polyamine compound corresponding to formula 1 or 2 below:

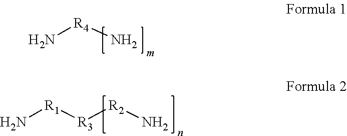

in which:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), chosen from O, N, S and Si;
m is equal to 1, 2 or 3;
n is equal to 1, 2 or 3,
in an amount between 0 and 7 mmol per 100 g of elastomer.

As primary polyamine compounds, the compounds having two, three or four primary amine functions are preferably used.

The polyamines corresponding to formula 1 may be, for example:

1,2-propylenediamine, 3,3′-dimethyl-4,4′-diaminodicyclohexylmethane, 4,4′ -diaminodicyclohexylmethane, isophore diamine, neopentanediamine (2,2-dimethylpropane-1,3-diamine), 1,8-octamethylenediamine, molten 4,4′-methylenedianiline, ethylenediamine, 1,3-diaminopropane, 1,6-hexamethylenediamine, 1,4-phenylenediamine, 1,3-phenylenediamine, 1,2-phenylenediamine, 1,2-diaminocyclohexane, 1,3-diaminocyclohexane, 1,4-diaminocyclohexane, 1,3-diamino-4-methylbenzene and preferably 1,8-octamethylenediamine, 1,6-hexamethylenediamine, 1,2-diaminocyclohexane and 1,4-diaminocyclohexane.

The polyamines corresponding to formula 2 may be, for example:

4,7,10-trioxatridecane-1,13-diamine, 4,9-dioxadodecane-1,12-diamine, diethylenetriamine, N-3-amine-(3-(2-aminoethylamino)propylamine), dipropylene triamine, N,N-bis(3-aminopropyl)methylamine, N-4-amine-(N,N′-bis(3-aminopropyl)ethylenediamine), 2,4-diamino-6-methyl-1,3,5-triazine, 2,4-diamino-6-phenyl-s-triazine, melamine, triethylenetetramine, tetraethylenepentamine, 2,2′,2″-nitrilotriethylamine, 3,6-dioxaoctane-1,8-diamine, N,N,N-tris(2-aminoethyl)amine, bis(3-aminopropyl)tetramethyldisiloxane, 2-(2-aminoethoxy)ethanamine, 3-{2-[2-(3-aminopropoxy)ethoxy]ethoxy}propan-1-amine, 3-[4-(3-aminopropoxy)phenoxy]propan-1-amine, 3-{2-(3-aminopropoxy)-1-[(3-aminopropoxy) methyl]ethoxy}propan-1-amine, 2-({2-[(2-aminophenyl)thio]ethyl}thio)aniline, 2-[(3-{[(2-aminophenyl)thio]methyl}-2,4,6-trimethylbenzyl)thio]aniline, 2-({4-[(2-aminophenyl)thio]but-2-enyl}thio)aniline and preferably N,N-bis (2-aminoethyl)ethane-1,2-diamine.

According to the present invention, the polyamine compounds corresponding to the formula 1 or 2 are preferably chosen from those for which R₁, R₂ and R₄ are each a hydrocarbon-based radical chosen from unsubstituted, linear or branched, alkylidene radicals having 2 to 8 carbon atoms and cycloalkylidene radicals having 6 carbon atoms and R₃ is an unsubstituted alkylidene radical having from 2 to 8 carbon atoms or an alkylidene radical having from 2 to 6 carbon atoms comprising N as heteroatom.

More preferably, the polyamine compounds are chosen from the following primary amines: 1,4-diaminocyclohexane, 1,2-diaminocyclohexane, N,N-bis(2-aminoethyl)ethane-1,2-diamine, 1,8-octamethylenediamine, 1,6-hexamethylenediamine.

The rubber composition of the tyre component according to the invention comprises the polyamine compound in an amount between 0 and 7 mmol per 100 g of elastomer, preferably ranging from 1 to 6 mmol, that is to say, comprises a small proportion of polyamine compound. In the case of a diamine having a short alkylidene chain, that is to say having C1 to C8 chains, the above amounts correspond to an amount between 0 and 1 phr, and preferably ranging from 0.2 to 0.9 phr. the expression “polyamine compound” according to the invention should be understood to mean a compound or a mixture of several compounds of formula 1 or 2.

According to the invention, the elastomeric matrix of the composition is based on natural rubber. In some cases, the elastomeric matrix can advantageously be entirely composed of natural rubber (100% of the elastomeric matrix is composed of natural rubber). This alternative form is preferably employed when it is a matter of using the rubber composition to manufacture sidewalls or treads for tyres of utility vehicles, such as heavy vehicles, or else certain applications, such as ice or snow, of passenger vehicles, or else to manufacture metal reinforcement/rubber composites, such as, for example, crown or carcass plies.

The natural rubber present in the elastomeric matrix is a non-halogenated natural rubber.

The elastomeric matrix can also comprise, in addition to natural rubber, at least one other diene elastomer.

In this case, this or these other diene elastomers are then present in the matrix in proportions of between 0 and 50% by weight (the limits of this range being excluded), preferably from 5% to 40%, more preferably still from 15% to 40%.

In the case of a blend with at least one other diene elastomer, the weight fraction of non-halogenated natural rubber in the elastomeric matrix is predominant and preferably greater than or equal to 50% by weight of the total weight of the matrix, more preferably still from 60% to 85% by weight of the total weight of the matrix.

Predominant weight fraction according to the invention refers to the highest weight fraction of the blend. Thus, in a ternary NR/elastomer A/elastomer B blend, the weight fractions can be distributed in the proportions 45/30/25 or 40/40/20 or 40/30/30, the predominant weight fractions being respectively 45 or 40, and, in a binary NR/elastomer blend, the weight fractions can be distributed in the proportions 50/50 or 70/30, the predominant weight fractions being 50 or 70.

The term “diene elastomer” should be understood according to the invention as meaning any, optionally functionalized, natural rubber or any synthetic elastomer resulting at least in part from diene monomers. More particularly, the term “diene elastomer” is understood to mean any homopolymer obtained by polymerization of a conjugated diene monomer having from 4 to 12 carbon atoms or any copolymer obtained by copolymerization of one or more conjugated dienes with one another or with one or more vinylaromatic compounds having from 8 to 20 carbon atoms. In the case of copolymers, the latter comprise from 20% to 99% by weight of diene units and from 1% to 80% by weight of vinylaromatic units. The optionally functionalized natural rubber is preferably an epoxidised rubber.

The diene elastomer constituting a portion of the elastomeric matrix according to the invention is preferably chosen from the group of highly unsaturated diene elastomers consisting of polybutadienes (BRs), butadiene copolymers, polyisoprenes (PIs), isoprene copolymers and the mixtures of these elastomers. Such copolymers are more preferably chosen from the group consisting of copolymers of butadiene and of a vinylaromatic monomer, more particularly the butadiene/styrene copolymer (SBR), isoprene/butadiene copolymers (BIRs), copolymers of isoprene and of a vinylaromatic monomer, more particularly the isoprene/styrene copolymer (SIR), and isoprene/butadiene/styrene copolymers (SBIRs). Particular preference is given, among these copolymers, to copolymers of butadiene and of a vinylaromatic monomer, more particularly the butadiene/styrene copolymer (SBR).

The diene elastomer constituting a portion of the elastomeric matrix according to the invention may or may not be star-branched, coupled or functionalized, in a way known per se, by means of functionalization, coupling or star-branching agents known to a person skilled in the art. Mention may be made, for example, among others more conventional, of the elastomers coupled according to the processes described in the patent applications in the name of the Applicant Companies WO 08/141702, FR 2 2910 64, FR 2 291 065 and FR 07/60442.

The rubber composition according to the invention comprises at least three compounds, including a reinforcing filler in proportions ranging from 35 to 200 phr. Preferably, the content of total reinforcing filler is between 40 and 140 phr, more preferably between 50 and 130 phr, the optimum being, in a known way, different depending on the specific applications targeted for the tyre; the expected level of reinforcement with regard to a bicycle tyre, for example, is, of course, lower than that required with regard to a tyre capable of running at high speed in a sustained manner, for example a motorcycle tyre, a tyre for a passenger vehicle or a tyre for a utility vehicle, such as a heavy vehicle.

The reinforcing filler is composed of a reinforcing organic filler, such as carbon black, or of a reinforcing inorganic filler, such as reinforcing silica, in proportions ranging from 0 to 100% by weight of the total weight of the composition, or of an organic filler/inorganic filler blend depending on the application targeted. The proportion of organic or inorganic filler is respectively preferably greater than or equal to 50% by weight of the total weight of the composition, more particularly greater than 55% depending on the application targeted. The second reinforcing filler contained in the blend (mixture) with the predominant reinforcing filler is then preferably present in a weight fraction of less than 50% relative to the total weight of the composition.

The term “reinforcing inorganic filler” should be understood in the present patent application, by definition, as meaning any inorganic or mineral filler, whatever its colour or its origin (natural or synthetic), also known as “white filler”, “clear filler”, indeed even “non-black filler”, in contrast to a conventional organic filler, such as carbon black, capable of reinforcing by itself alone, without means other than an intermediate coupling agent, a rubber composition intended for the manufacture of tyres, in other words capable of replacing, in its reinforcing role, a conventional tyre-grade carbon black; such a filler is generally characterized, in a known way, by the presence of hydroxyl (—OH) groups at its surface.

The silica used can be any reinforcing silica known to a person skilled in the art, in particular any precipitated or pyrogenic silica exhibiting a BET surface area and a CTAB specific surface area both of less than 450 m²/g, even if highly dispersible precipitated silicas are preferred. Mention will also be made, as reinforcing inorganic filler, of mineral fillers of the aluminous type, in particular alumina (Al₂O₃) or aluminium (oxide)hydroxides, or else reinforcing titanium oxides.

The physical state in which the reinforcing inorganic filler is provided is immaterial, whether in the powder, microbead, granule or bead form. Of course, the term “reinforcing inorganic filler” is also understood to mean mixtures of various reinforcing inorganic fillers, in particular of highly dispersible silicas as described above.

All carbon blacks, in particular blacks of the HAF, ISAF, SAF, FF, FEF, GPF and SRF types, conventionally used in tyre rubber compositions (“tyre-grade” blacks) are suitable as reinforcing organic filler. Mention will more particularly be made, among the latter, of the reinforcing carbon blacks of the 100, 200 or 300 series (ASTM grades), such as, for example, the N115, N134, N234, N326, N330, N339, N347 or N375 blacks, but also coarser blacks, such as, for example, the N550 or N683 blacks. The carbon blacks might, for example, be already incorporated in the natural rubber in the form of a masterbatch. The black/silica blends or the blacks partially or fully covered with silica are suitable for forming the reinforcing filler. Carbon blacks modified by silica, such as, without implied limitation, the fillers which are sold by Cabot under the name “CRX 2000”, and which are described in the international patent document WO-A-96/37547, are also suitable.

Mention may be made, as examples of reinforcing organic fillers other than carbon blacks, of functionalized polyvinylaromatic organic fillers, as described in patent applications WO-A-2006/069792 and WO-A-2006/069793, or else of functionalized nonaromatic polyvinyl organic fillers, as described in patent applications WO-A-2008/003434 and WO-A-2008/003435.

In the case where the reinforcing filler comprises only a predominant reinforcing inorganic filler and carbon black, the weight fraction of this carbon black in said reinforcing filler is more preferably chosen to be less than or equal to 30%, relative to the total weight of the reinforcing filler.

In the case where the reinforcing filler comprises a reinforcing inorganic filler, the rubber composition according to the invention comprises at least four compounds, including a coupling agent for coupling the reinforcing inorganic filler to the natural rubber and to the optional diene elastomers which make up the elastomeric matrix.

The term “coupling agent” is understood to mean more specifically an agent capable of establishing a satisfactory connection of chemical and/or physical nature between the filler in question and the elastomer, while facilitating the dispersion of this filler within the elastomeric matrix. Such an at least bifunctional bonding agent has, for example, the simplified general formula “Y-T-X′”, in which:
Y represents a functional group (“Y” function) which is capable of being bonded physically and/or chemically to the inorganic filler, it being possible for such a bond to be established, for example, between a silicon atom of the coupling agent and the surface hydroxyl (—OH) groups of the inorganic filler (for example the surface silanols, when silica is concerned);
X′ represents a functional group (“X′” function) capable of being bonded physically and/or chemically to the elastomer, for example via a sulphur atom;
T represents a divalent group which makes it possible to connect Y and X′.

Agents referred to as covering agents for covering inorganic filler particles may also be used, which are capable of further improving, by bonding to the surface functional sites of the inorganic filler and by thus covering it at least partially, the dispersion of this inorganic filler in the elastomeric matrix, thus lowering its viscosity in the uncured state and on the whole improving its processability in the uncured state.

Such covering agents essentially belong to the family of polyols (for example diols, triols such as glycerol or its derivatives), polyethers (for example polyethylene glycols), primary, secondary or tertiary amines (for example trialkanolamines), hydroxylated or hydrolysable polyorganosiloxanes, for example α,ω-dihydroxypolyorganosilanes (in particular α,ω-dihydroxypolydimethylsiloxanes), hydroxysilanes, alkylalkoxysilanes, in particular alkyltriethoxysilanes, such as for example 1-octyltriethoxysilane sold by Degussa-Evonik under the name Dynasylan Octeo. These covering agents are well known in tyre rubber compositions reinforced with an inorganic filler; they have been described, for example, in patent applications WO 00/05300, WO 01/55252, WO 01/96442, WO 02/031041, WO 02/053634, WO 02/083782, WO 03/002648, WO 03/002653, WO 03/016387, WO 2006/002993, WO 2006/125533, WO 2007/017060 and WO 2007/003408.

The bonding agents must not be confused with simple agents for covering the filler in question which, in a known way, can comprise the Y function that is active with regard to the filler but are devoid of the X′ function that is active with regard to the elastomer. Use may be made of any bonding agent known for or capable of efficiently providing, in the rubber compositions which can be used for the manufacture of tyres, the bonding (or the coupling) between a reinforcing inorganic filler, such as silica, and a diene elastomer, such as, for example, organosilanes, in particular alkoxysilane polysulphides or mercaptosilanes, or polyorganosiloxanes bearing the abovementioned X′ and Y functions. Silica/elastomer bonding agents, in particular, have been described in a large number of documents, the most well known being bifunctional alkoxysilanes, such as alkoxysilane polysulphides. Use is made in particular of silane polysulphides, known as “symmetrical” or “unsymmetrical” according to their specific structure, as described, for example, in patent applications WO 03/002648 (or US 2005/016651) and WO 03/002649 (or US 2005/016650).

Mention will more particularly be made, as examples of silane polysulphides, of bis(3-trimethoxysilylpropyl) or bis(3-triethoxysilylpropyl) polysulphides. Use is made in particular, among these compounds, of bis(3-triethoxysilylpropyl) tetrasulphide, abbreviated to TESPT, or of bis(3-triethoxysilylpropyl) disulphide, abbreviated to TESPD. Mention will also be made, as preferred examples, of bis(mono(C₁-C₄)alkoxydi(C₁-C₄)alkylsilylpropyl) polysulphides (in particular disulphides, trisulphides or tetrasulphides), more particularly bis(monoethoxydimethylsilylpropyl) tetrasulphide, as described in patent application WO 02/083782 (or US 2004/132880).

Mention will in particular be made, as coupling agent other than alkoxysilane polysulphide, of bifunctional POSs (polyorganosiloxanes), or else of hydroxysilane polysulphides, as described in patent applications WO 02/30939 (or U.S. Pat. No. 6,774,255) and WO 02/31041 (or US 2004/051210), or else of silanes or POSs bearing azodicarbonyl functional groups, as described, for example, in patent applications WO 2006/125532, WO 2006/125533 and WO 2006/125534.

Mention will for example be made, as examples of other silane sulphides, of other silanes bearing at least one thiol (SH) function (referred to as mercaptosilanes) and/or at least one blocked thiol function, as described, for example, in patents or patent applications U.S. Pat. No. 6,849,754, WO 99/09036, WO 2006/023815 and WO 2007/098080.

Of course, mixtures of the coupling agents described above could also be used, as described, in particular, in patent application WO 2006/125534.

In the compositions in accordance with the invention, the content of coupling agent is advantageously less than 20 phr, it being understood that it is generally desirable to use as little as possible thereof. The content thereof is preferably between 0.5 and 12 phr, more preferably from 3 to 10 phr, in particular from 4 to 7 phr. This content is easily adjusted by a person skilled in the art according to the content of inorganic filler used in the composition.

A person skilled in the art will understand that use might be made, as filler equivalent to the reinforcing inorganic filler described in the present section, of a reinforcing filler of another nature, in particular organic nature, provided that this reinforcing filler is covered with an inorganic layer, such as silica, for instance, without implied limitation, the fillers which are sold by Cabot under the name “CRX 2000”, and which are described in the international patent document WO-A-96/37547, or else comprises, at its surface, functional sites, in particular hydroxyl sites, requiring the use of a coupling agent in order to establish the connection between the filler and the elastomer.

The rubber compositions in accordance with the invention can also comprise, in addition to coupling agents, coupling activators, agents for covering the inorganic fillers as described above, or more generally processing aids capable, in a known way, by virtue of an improvement in the dispersion of the filler in the rubber matrix and of a lowering in the viscosity of the compositions, of improving their ability to be processed in the uncured state, these agents being, for example, hydrolysable silanes, such as alkylalkoxysilanes, polyols, polyethers, primary, secondary or tertiary amines, or hydroxylated or hydrolysable polyorganosiloxanes.

The rubber compositions in accordance with the invention can also comprise all or some of the usual additives generally used in elastomer compositions intended for the manufacture of tyres, such as, for example, pigments, protection agents, such as antiozone waxes, chemical antiozonants, antioxidants, antifatigue agents, reinforcing or plasticizing resins, methylene acceptors (for example, phenol-novolac resin) or methylene donors (for example, HMT or H3M), as described, for example, in patent application WO 02/10269, a crosslinking system based either on sulphur or on sulphur donors and/or on peroxide and/or on bismaleimides, vulcanization accelerators, vulcanization activators, adhesion promoters, such as cobalt-based compounds, plasticizing agents, preferably nonaromatic or very slightly aromatic plasticizing agents chosen from the group consisting of naphthenic oils, paraffinic oils, MES oils or TDAE oils, ether plasticizers, ester plasticizers (for example, glycerol trioleates), and hydrocarbon-based resins having a high T_{g}, preferably of greater than 30° C., as described, for example, in patent applications WO 2005/087859, WO 2006/061064 and WO 2007/017060, and the mixtures of such compounds.

The invention also relates to a process for the preparation of a rubber composition as described above.

It should be pointed out that, according to the invention, the polyamine compound can be incorporated, on an open device of open mill (external mixer) type or on a closed device of internal mixer type, at any point in the process for the preparation of the rubber composition described above, including during the manufacture of the natural rubber on the site for the production thereof.

The composition is manufactured in appropriate mixers using two successive preparation phases well known to a person skilled in the art: (i) a first phase of thermomechanical working or kneading (phase referred to as “non-productive”) at high temperature, up to a maximum temperature of between 130° C. and 200° C., preferably between 145° C. and 185° C., followed (ii) by a second phase of mechanical working (phase referred to as “productive”) down to a lower temperature, typically of less than 110° C., for example between 40° C. and 100° C., also referred to as a finishing phase, during which the crosslinking system is incorporated. The expression “crosslinking system” is understood to mean either the crosslinking agents conventionally used with inorganic fillers or the vulcanization agents conventionally used such as sulphur or the vulcanization accelerators.

By way of example, the first (non-productive) phase is carried out in a single thermomechanical stage during which, in a first step at a temperature between 55° C. and 80° C., for example around 70° C., the diene elastomer(s) is (are) introduced into an appropriate mixer, such as an internal mixer, followed, in a second step at a temperature between 80° C. and 110° C., for example around 100° C., by the introduction of the reinforcing filler, the primary polyamine compound in the aforementioned low content, the optional additional processing aids and the other additives, with the exception of the crosslinking or vulcanization system. The total kneading time, in this non-productive phase, is preferably between 2 and 6 minutes with a maximum dropping temperature of 180° C.

After cooling the mixture thus obtained, the vulcanization system is then incorporated at a temperature between 20° C. and 50° C., for example around 30° C., generally in an external mixer, such as an open mill; the combined mixture is then mixed (productive phase) for a few minutes, for example between 2 and 6 minutes.

The process in accordance with the invention for preparing a rubber composition according to the invention comprises at least the following stages:
carrying out, at a maximum temperature of between 130° C. and 200° C., preferably between 145° C. and 185° C., for a time preferably of between 2 and 6 minutes, a first step of thermomechanical working (sometimes described as “non-productive” phase) of the necessary base constituents of the rubber composition and of the primary polyamine compound in the aforementioned low content, with the exception of the crosslinking system, by intimately incorporating, by kneading in one or more stages, the constituents of the composition in the elastomeric matrix based on natural rubber, then
carrying out, at a temperature lower than said maximum temperature of said first step, preferably of less than 110° C., for a time preferably of between 2 and 6 minutes, a second step of mechanical working (sometimes described as “productive” phase) advantageously on an open mill, during which said crosslinking system is incorporated.

It should be noted that, according to the process in accordance with the invention, the primary polyamine compound that must be incorporated into the composition must be incorporated at a low content, i.e. at a content between 0 and 7 mmol per 100 g of elastomer and preferably ranging from 1 to 6 mmol per 100 g of elastomer.

The polyamine compound corresponding to formula 1 or 2 described above can thus be incorporated:
either as additive during the manufacture of the natural rubber on the site for the production thereof,
or as ingredient of the rubber composition according to the invention:
   during the preliminary preparation of a natural rubber/polyamine masterbatch on an open device of open mill (external mixer) type or on a closed device of internal mixer type,
   without preliminary preparation of a masterbatch, directly in the internal mixer during the first non-productive phase with the other compounds of the rubber composition.

This is why, according to one alternative form of the process according to the invention, said alternative form comprises, prior to carrying out the abovementioned stage (i), the stages of the conventional manufacture of natural rubber which comprises the addition of the polyamine compound.

Another alternative form of the process according to the invention comprises, prior to carrying out the abovementioned stage (i), a stage of preparation of a masterbatch based on non-halogenated natural rubber and on the polyamine compound corresponding to formula 1 or 2.

According to another alternative form of the process of the invention, all the base constituents of the composition of the invention, including the polyamine compound but with the exception of the vulcanization system, are incorporated during the first stage (i), the “non-productive” phase.

The final composition thus obtained can then be calendered, for example in the form of a sheet or slab, or else extruded, for example to form a rubber profiled element that can be used as a semi-finished rubber product intended for a tyre.

Another subject of the invention is a tyre which incorporates, in at least one of its constituent components, a reinforced rubber composition according to the invention.

One subject of the invention is very particularly a semi-finished rubber product, comprising a reinforced rubber composition according to the invention, intended for these tyres.

Due to the reduced hysteresis which characterizes a reinforced rubber composition according to the invention, compared to the hysteresis of the composition free of polyamine compound, it should be noted that a tyre having a tread comprising the composition according to the invention exhibits improved hysteresis properties, and in particular makes it possible to significantly decrease the initial hysteresis of the composition which is synonymous with an advantageously reduced rolling resistance.

Due to the reduced hysteresis which characterizes a reinforced rubber composition according to the invention, compared to the hysteresis of a composition free of polyamine compound, it should also be noted that a tyre, the sidewalls or all or some of the inner compositions of which comprise the composition of the invention, exhibits a significantly reduced self-heating and thus an improved endurance. The term “inner compositions” is understood to mean the compositions intended for manufacturing crown reinforcement plies, carcass reinforcement plies, beads, protectors, under layers, rubber blocks and other inner liners, especially decoupling rubbers, intended to provide the bonding or interface between the aforementioned regions of the tyres.

The tyres in accordance with the invention are in particular intended for passenger vehicles, for industrial vehicles chosen from vans, heavy vehicles, i.e. underground trains, buses, heavy road transport vehicles (lorries, tractors, trailers) or off-road vehicles, heavy agricultural vehicles or earth-moving equipment, planes, and other transportation or handling vehicles.

The abovementioned features of the present invention, and others, will be better understood on reading the following description of several exemplary embodiments of the invention, given by way of illustration and without implied limitation.

### I. MEASUREMENTS AND TESTS USED

The rubber compositions are characterized before and after curing, as indicated below:

(a) The Mooney viscosity (ML 1+4) at 100° C.: measured according to the ASTM: D-1646 standard, entitled “Mooney” in the tables.

(b) The Shore A hardness: measurements carried out according to the DIN 53505 standard.

(c) The Scott fracture index at 23° C.: the tensile strength (TS) is determined in MPa and the elongation at break (EB) is determined in %. All these tensile measurements are carried out under standard temperature and humidity conditions according to the ISO 37 standard.

(d) The dynamic property tan(δ)max is measured on a viscosity analyser (Metravib VA4000) according to the ASTM D 5992-96 standard. The response of a sample of vulcanized composition (cylindrical test specimen with a thickness of 2 mm and with a cross section of 79 mm²), subjected to a simple alternating sinusoidal shear stress, at a frequency of 10 Hz, under standard temperature conditions (23° C.) according to the ASTM D 1349-99 standard, is recorded. A peak-to-peak strain amplitude sweep is carried out from 0.1 to 50% (outward cycle) and then from 50 to 0.1% (return cycle). The results made use of are the loss factor tan δ. The maximum value of tan δ observed (tan(δ)max) is shown for the return cycle.

### II. MASTERBATCH PREPARATION

Several polyamine molecules were used as an additive for natural rubber in order to manufacture a masterbatch in accordance with a variant of the process of the invention:
1,6-hexamethylenediamine (HMDA),
1,8-octamethylenediamine (DAO),
1,4-diaminocyclohexane (1,4DACH),
N,N-bis(2-aminoethyl)ethane-1,2-diamine (TAEA).

The natural rubber used to form the masterbatches (M . . . , for example, MC, MD or ME) is an NR referenced TSR20.

The method of incorporating the molecule is as follows:

The natural rubber is subjected, on an open mill, the rolls of which have a diameter equal to 150 mm, a nip equal to 2 mm and a rotational speed of the rolls of 20 rpm, to the following stages:
1) 3 passes of the natural rubber initially at ambient temperature;
2) addition of a given amount of polyamine compound in powder form;
3) carrying out 12 passes so as to disperse the powder and to homogenize the sample.

The breakdown is given in Table 1 below.

The stages that the natural rubber is subjected to are indicated by a cross in the table.

TABLE 1

| Elas- | | | | Amount | | | |
|---|---|---|---|---|---|---|---|
| tomer | | | | in mmol | | | |
| or | | | | per 100 g | | | |
| master- | | | Amount | of | Stage | Stage | Stage |
| batch | Type | Polyamine | in phr | elastomer | 1 | 2 | 3 |
| B | TSR20 | | | | X | | X |
| MC | TSR20 | HMDA | 0.30 | 2.6 | X | X | X |
| MD | TSR20 | TAEA | 0.25 | 1.7 | X | X | X |
| ME | TSR20 | 1,4- | 0.29 | 2.6 | X | X | X |
| | | DACH | | | | | |

The amounts of the various polyamines added are identical in terms of number of moles of primary amine functions.

### III. EXEMPLARY EMBODIMENTS OF THE INVENTION

The objective of the exemplary embodiments is to compare the properties of a composition in accordance with the invention that comprises a polyamine compound at a low content and which is prepared according to the process in accordance with the invention with another composition that is identical except that it does not comprise a polyamine compound. The procedure for producing the compositions is the same for all the compositions tested.

The examples show the improved properties, in particular the hysteresis of a composition in accordance with the invention, when the reinforcing filler is 100% an organic filler such as carbon black.

### Example 1

The compositions tested have the following formulation (expressed in phr: parts per hundred parts of elastomer):

| | |
|---|---|
| Diene elastomer (1) | 100 |
| Filler (2) | 54 |
| Antioxidant (3) | 4 |
| Paraffin | 1 |
| Stearic acid (4) | 1.5 |
| ZnO (5) | 3 |
| Accelerator (6) | 1.1 |
| Sulphur | 1.1 |

(1) = Natural rubber
(2) = Carbon black N234
(3) = N-(1,3-Dimethylbutyl)-N′-phenyl-p-phenylenediamine (“Santoflex 6-PPD” from Flexsys)
(4) = “Pristerene 4931” from Uniquema
(5) = industrial grade from Umicore
(6) = CBS from Flexsys

Each of the compositions is produced, in a first step, by thermomechanical working and then, in a second finishing step, by mechanical working.

The elastomer and, 30 seconds later, the carbon black, the stearic acid, the zinc oxide, the antioxidant and the paraffin are successively introduced into a laboratory internal mixer of “Banbury” type, the capacity of which is 85 cm³, which is 70% filled and which has a starting temperature of approximately 80° C.

The stage of thermomechanical working is carried out for 3 to 6 minutes, up to a maximum dropping temperature of approximately 165° C.

The first abovementioned step of thermomechanical working is thus carried out, it being specified that the mean speed of the blades during this first step is 70 rpm.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of slabs (with a thickness ranging from 2 to 3 mm) or fine sheets of rubber, for the measurement of their properties before and after crosslinking.

The compositions thus obtained can also be extruded in the form of profiled elements which can be used directly, after cutting and/or assembling to the desired dimensions, for example as tyre semi-finished products.

Results obtained:

TABLE 2

| Composition | B | C | D | E |
|---|---|---|---|---|
| Elastomer or masterbatch | B | MC | MD | ME |
| Properties in the uncrosslinked state | | | | |
| ML 1 + 4 at 100° C. | 100 | 121 | 108 | 113 |
| (“Mooney mixture”) | | | | |
| Dynamic properties as a function of | | | | |
| the strain | | | | |
| tan (δ) max at 23° C. | 100 | 91 | 94 | 94 |

It should be noted that the compositions C, D and E according to the invention exhibit a “Mooney mixture” value which is greater than that of the composition B based on an NR merely worked on the device.

As regards the dynamic properties, it should be noted that the values of tan (δ) max at 23° C. of the compositions C, D and E are lower than those of the composition B based on an NR merely passed through the device.

The masterbatches MC, MD or ME comprising a polyamine according to the invention make it possible to improve the hysteresis properties, with respect to the natural rubber B passed through the device without introduction of molecule.

In other words, the compositions C, D and E according to the invention based on NR comprising a polyamine exhibit rubber properties in the crosslinked state which are improved, with respect to those of the composition B based on unmodified NR, as a result of a reduced hysteresis.

### Example 2

The compositions tested are prepared without prior production and with prior production of a masterbatch as described above.

### Masterbatch Route:

The breakdown is given in Table 3 below.

The stages that the natural rubber is subjected to are indicated by a cross in the table.

TABLE 3

| Elas- | | | | Amount | | | |
|---|---|---|---|---|---|---|---|
| tomer | | | | in mmol | | | |
| or | | | | per 100 g | | | |
| master- | | | Amount | of | Stage | Stage | Stage |
| batch | Type | Polyamine | in phr | elastomer | 1 | 2 | 3 |
| A | TSR20 | | | | | | |
| B | TSR20 | | | | X | | X |
| MF | TSR20 | HMDA | 0.3 | 2.6 | X | X | X |
| MH | TSR20 | HMDA | 0.7 | 6.0 | X | X | X |
| MI | TSR20 | DAO | 0.37 | 2.6 | X | X | X |
| MJ | TSR20 | DAO | 0.62 | 4.3 | X | X | X |
| MK | TSR20 | DAO | 0.87 | 6.0 | X | X | X |

### Direct Introduction Into the Internal Mixer

The breakdown is given in Table 4 below.

TABLE 4

| | | | | Amount in | |
|---|---|---|---|---|---|
| | | | | mmol per | |
| Mixture | | Poly- | Amount | 100 g of | |
| reference | Type | amine | in phr | elastomer | Introduction |
| MI L | TSR20 | DAO | 0.62 | 4.3 | into the internal |
| | | | | | mixer at the same |
| | | | | | time as the |
| | | | | | elastomer |

The compositions tested have the same formulation as that described in Example 1.

Each of the following compositions is produced, in a first step, by thermomechanical working and then, in a second finishing step, by mechanical working.

The elastomer or masterbatch is introduced into a laboratory internal mixer of “Banbury” type, the capacity of which is 400 cm³, which is 75% filled and which has a starting temperature of approximately 70° C. At 100° C., the carbon black, the stearic acid, the zinc oxide, the antioxidant, the paraffin and, in the case of the MI L mixture, the polyamine are introduced.

The stage of thermomechanical working is carried out for 3 to 5 minutes.

The first abovementioned step of thermomechanical working is thus carried out, it being specified that the mean speed of the blades during this first step is 65-70 rpm.

The mixture thus obtained is recovered and cooled and then, in an external mixer (homofinisher), the sulphur and the sulphenamide are added at 30° C., the combined mixture being further mixed for a time of 3 to 4 minutes (second abovementioned step of mechanical working).

The compositions thus obtained are subsequently calendered, either in the form of slabs (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tyre semi-finished products.

Compositions A, B, F, H, I, J and K; the breakdown is given in Table 5 below.

TABLE 5

| | Composition | | | | | | |
|---|---|---|---|---|---|---|---|
| | A | B | F | H | I | J | K |
| | Elastomer or masterbatch | | | | | | |
| | A | B | MF | MH | MI | MJ | MK |
| Properties in the | | | | | | | |
| uncrosslinked state | | | | | | | |
| ML 1 + 4 at 100° C. | 100 | 92 | 117 | 120 | 120 | 124 | 129 |
| (“Mooney mixture”) | | | | | | | |
| Properties in the | | | | | | | |
| crosslinked state | | | | | | | |
| Shore A at 23° C. | 100 | 101 | 103 | 103 | 102 | 105 | 103 |
| Scott fracture | | | | | | | |
| index at 23° C. | | | | | | | |
| TS | 100 | 99 | 104 | 105 | 104 | 106 | 107 |
| EB (%) | 555 | 538 | 541 | 541 | 524 | 542 | 536 |
| Dynamic properties as | | | | | | | |
| a function of the strain | | | | | | | |
| tan (δ) max at 23° C. | 100 | 106 | 96 | 95 | 93 | 93 | 91 |

It should be noted that the compositions F, H, I, J and K according to the invention exhibit a “Mooney mixture” value which is greater than that of composition A based on an unmodified NR and that of composition B based on an NR passed through the device without introduction of polyamine molecule.

As regards the dynamic properties, it should be noted that the tan(δ)max values of the compositions F, H, I, J and K are lower than that of composition A based on an unmodified NR and that of composition B based on an NR passed through the device without introduction of molecule.

In other words, the compositions F, H, I, J and K according to the invention based on NR comprising a diamine have rubber properties in the crosslinked state which are improved relative to those of composition A based on an unmodified NR and those of composition B based on an NR passed through the device without introduction of polyamine compound as a result of a substantially reduced tan (δ) hysteresis.

Compositions J and L: introduction effect; the breakdown is given in Table 6 below.

TABLE 6

| Composition | A | J | L |
|---|---|---|---|
| Elastomer or masterbatch | A | MJ | MI L |
| Properties in the uncrosslinked state | | | |
| ML 1 + 4 at 100° C. | 100 | 124 | 128 |
| (“Mooney mixture”) | | | |
| Properties in the crosslinked state | | | |
| Shore A at 23° C. | 100 | 105 | 105 |
| Scott fracture index at 23° C. | | | |
| TS | 100 | 106 | 106 |
| EB (%) | 555 | 542 | 519 |
| Dynamic properties as a function of | | | |
| the strain | | | |
| tan (δ) max at 23° C. | 100 | 93 | 95 |

It should be noted that the compositions J and L according to the invention exhibit a “Mooney mixture” value which is greater than that of composition A based on an unmodified NR.

As regards the dynamic properties, it should be noted that the tan(δ)max values of the compositions J and L are lower than that of composition A based on an unmodified NR.

The masterbatch route MJ or the direct introduction MI L comprising the same diamine according to the invention makes it possible to improve the hysteresis properties of the compositions based on NR relative to those of composition A that is not modified by the addition of a polyamine.

In other words, the compositions J and L according to the invention based on NR comprising a diamine introduced into the natural rubber, either before producing the mixture in the mixer (masterbatch route), or introduced directly during the production of the mixture, have rubber properties in the crosslinked state which are improved relative to those of composition A based on an unmodified NR as a result of a reduced tan (δ) hysteresis.

### Example 3

The compositions tested are prepared without prior production of a masterbatch or with prior production of a masterbatch or with production of a masterbatch in the internal mixer.

### Masterbatch Route:

The breakdown is given in Table 7 below.

The stages that the natural rubber is subjected to are indicated by a cross in the table.

TABLE 7

| Elas- | | | | Amount | | | |
|---|---|---|---|---|---|---|---|
| tomer | | | | in mmol | | | |
| or | | | | per 100 g | | | |
| master- | | | Amount | of | Stage | Stage | Stage |
| batch | Type | Polyamine | in phr | elastomer | 1 | 2 | 3 |
| A | TSR20 | | | | | | |
| B | TSR20 | | | | X | | X |
| MM | TSR20 | DAO | 0.2 | 1.4 | X | X | X |
| MN | TSR20 | DAO | 0.37 | 2.6 | X | X | X |
| MO | TSR20 | DAO | 0.62 | 4.3 | X | X | X |
| MP | TSR20 | DAO | 0.87 | 6.0 | X | X | X |

Direct Introduction into the Internal Mixer

The breakdown is given in Table 8 below.

TABLE 8

| | | | | Amount in | |
|---|---|---|---|---|---|
| | | | | mmol per | |
| Mixture | | Poly- | Amount | 100 g of | |
| reference | Type | amine | in phr | elastomer | Introduction |
| MI Q | TSR20 | DAO | 0.2 | 1.4 | at the same time as |
| | | | | | the elastomer into |
| | | | | | the internal mixer |
| MI R | TSR20 | DAO | 0.37 | 2.6 | at the same time as |
| | | | | | the elastomer into |
| | | | | | the internal mixer |
| MI S | TSR20 | DAO | 0.62 | 4.3 | at the same time as |
| | | | | | the elastomer into |
| | | | | | the internal mixer |
| MI T | TSR20 | DAO | 0.87 | 6.0 | at the same time as |
| | | | | | the elastomer into |
| | | | | | the internal mixer |

### Production of the Masterbatch in the Internal Mixer:

The breakdown is given in Table 9 below.

TABLE 9

| | | | | Amount in |
|---|---|---|---|---|
| | | | | mmol per |
| Mixture | | Poly- | Amount | 100 g of |
| reference | Type | amine | in phr | elastomer |
| MU | TSR20 | DAO | 0.37 | 2.6 |

The masterbatch MU was produced with a TSR20 NR, which was first modified in the internal mixer under the following conditions:

The elastomer is introduced into a laboratory internal mixer of “Banbury” type, the capacity of which is 400 cm³, which is 85% filled and which has a starting temperature of approximately 70° C. At 100° C., the DAO is introduced.

The stage of thermomechanical working is carried out for 3 to 5 minutes, up to a maximum dropping temperature of approximately 180° C.

The first abovementioned step of thermomechanical working is thus carried out, it being specified that the mean speed of the blades during this first step is 80 rpm.

Each of the compositions tested has the following formulation (expressed in phr: parts per hundred parts of elastomer):

| | |
|---|---|
| Diene elastomer (1) | 100 |
| Filler (2) | 54 |
| Antioxidant (3) | 4 |
| Paraffin | 1 |
| Stearic acid (4) | 1.5 |
| ZnO (5) | 3 |
| Accelerator (6) | 1.1 |
| Sulphur | 1.1 |
| CTP (7) | 0.3 |

(1) = Natural rubber
(2) = Carbon black N234
(3) = N-(1,3-Dimethylbutyl)-N′-phenyl-p-phenylenediamine (“Santoflex 6-PPD” from Flexsys)
(4) = “Pristerene 4931” from Uniquema
(5) = industrial grade from Umicore
(6) = CBS from Flexsys
(7) = cyclohexylthiophthalimide

Each of the following compositions is produced, in a first step, by thermomechanical working and then, in a second finishing step, by mechanical working.

The elastomer or the masterbatch is introduced into a laboratory internal mixer of “Banbury” type, the capacity of which is 400 cm³, which is 75% filled and which has a starting temperature of approximately 70° C. At 100° C., the carbon black, the stearic acid, the zinc oxide, the antioxidant, the paraffin and, in the case of the MI Q, MI R, MI S and MI T mixtures, the polyamine are introduced.

The stage of thermomechanical working is carried out for 3 to 5 minutes.

The first abovementioned step of thermomechanical working is thus carried out, it being specified that the mean speed of the blades during this first step is 65-70 rpm.

The mixture thus obtained is recovered and cooled and then, in an external mixer (homofinisher), the sulphur, the sulphenamide and the CTP are added at 30° C., the combined mixture being further mixed for a time of 3 to 4 minutes (second abovementioned step of mechanical working).

The compositions thus obtained are subsequently calendered, either in the form of slabs (with a thickness ranging from 2 to 3 mm) or fine sheets of rubber, for the measurement of their physical or mechanical properties.

The compositions thus obtained can also be extruded in the form of profiled elements which can be used directly, after cutting and/or assembling to the desired dimensions, for example as tyre semi-finished products.

Results obtained:

Compositions A, B, M, N, O, P, Q, R, S, T and U; the breakdown is given in Table 10 below:

TABLE 10

| | Compositions | | | | | | | | | | |
|---|---|---|---|---|---|---|---|---|---|---|---|
| | A | B | M | N | O | P | Q | R | S | T | U |
| | Elastomer or masterbatch | | | | | | | | | | |
| | A | B | MM | MN | MO | MP | MIQ | MIR | MIS | MIT | MU |
| Properties in the | | | | | | | | | | | |
| uncrosslinked state | | | | | | | | | | | |
| ML 1 + 4 at 100° C. | 100 | 106 | 107 | 118 | 127 | 121 | 121 | 129 | 131 | 131 | 122 |
| (“Mooney mixture”) | | | | | | | | | | | |
| Properties in the | | | | | | | | | | | |
| crosslinked state | | | | | | | | | | | |
| Shore A at 23° C. | 100 | 101 | 102 | 101 | 102 | 103 | 101 | 101 | 101 | 103 | 103 |
| Scott fracture index at | | | | | | | | | | | |
| 23° C. | | | | | | | | | | | |
| TS | 100 | 101 | 99 | 99 | 96 | 96 | 104 | 104 | 101 | 99 | 102 |
| EB (%) | 549 | 535 | 517 | 521 | 488 | 488 | 539 | 542 | 512 | 515 | 535 |
| Dynamic properties as a | | | | | | | | | | | |
| function of the strain | | | | | | | | | | | |
| tan (δ) max at 23° C. | 100 | 99 | 95 | 91 | 90 | 89 | 90 | 93 | 84 | 89 | 93 |

It should be noted that, on the one hand, the compositions M, N, O and P according to the invention exhibit a “Mooney mixture” value which is greater than that of composition A based on an NR that is not modified by the addition of a polyamine compound, and that of composition B based on an NR passed through the device without introduction of polyamine compound.

As regards the dynamic properties, it should be noted that the tan(δ)max values of the compositions M, N, O and P are lower than those of composition A based on an unmodified NR and that of composition B based on an NR passed through the device without introduction of molecule. In other words, the compositions M, N, O and P according to the invention based on NR comprising a diamine introduced into the natural rubber before producing the mixture in the mixer (masterbatch route) have rubber properties in the crosslinked state which are improved relative to those of composition A based on an unmodified NR as a result of a reduced tan (δ) max hysteresis.

It should be noted that, on the other hand, the compositions Q, R, S and T according to the invention exhibit a “Mooney mixture” value which is greater than that of composition A based on an NR that is not modified by the addition of a polyamine compound, and that of composition B based on an NR passed through the device without introduction of molecule.

As regards the dynamic properties, it should be noted that the tan(δ)max values of the compositions Q, R, S and T are lower than those of composition A based on an unmodified NR and that of composition B based on an NR passed through the device without introduction of molecule.

In other words, the compositions Q, R, S and T according to the invention based on NR comprising a diamine introduced into the mixer during production of the mixture have rubber properties in the crosslinked state which are improved relative to those of composition A based on an unmodified NR as a result of a reduced tan(δ) hysteresis.

Finally, irrespective of the method of introducing the polyamine compound into the natural rubber, either by the masterbatch route (masterbatch produced on the device or in the mixer) on the one hand, or by introducing the polyamine compound into the mixer on the other hand, the compositions N, R and U according to the invention exhibit a “Mooney mixture” value which is greater than that of composition A based on an unmodified NR and that of composition B based on an NR passed through the device without introduction of polyamine compound.

As regards the dynamic properties, it should be noted that the tan(δ)max values of the compositions N, R and U are lower than those of composition A based on an unmodified NR and that of composition B based on an NR passed through the device without introduction of polyamine compound.

In other words, the compositions N, R and U based on NR comprising a diamine introduced into the natural rubber according to the methods of introduction according to the invention have rubber properties in the crosslinked state which are improved relative to those of composition A based on an unmodified NR as a result of a reduced tan(δ) max hysteresis.

1. Reinforced rubber composition based at least (a) on an elastomeric matrix comprising non-halogenated natural rubber, (b) on a reinforcing filler, (c) on a primary polyamine compound having at least two primary amine functions corresponding to formula 1 or 2 below: 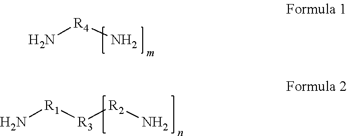
in which:
R₁ and R₂, which are identical or different, are selected from the group consisting of alkylidenes having from 1 to 20 carbon atoms, cycloalkylidenes having from 5 to 24 carbon atoms, arylidenes having from 6 to 18 carbon atoms, aralkylidenes having from 7 to 25 carbon atoms and heterocycles, which are identical or different, having from 4 to 25 carbon atoms;
R₃ and R₄, which are identical or different, are selected from the group consisting of alkylidenes having from 1 to 20 carbon atoms, alkylidynes having from 1 to 20 carbon atoms, alkylylidynes having from 1 to 20 carbon atoms, cycloalkylidenes having from 5 to 24 carbon atoms, cycloalkylidynes having from 5 to 24 carbon atoms, cycloalkylylidynes having from 5 to 24 carbon atoms, arylidenes having from 6 to 18 carbon atoms, arylidynes having from 6 to 18 carbon atoms, arylylidynes having from 6 to 18 carbon atoms, aralkylidenes having from 7 to 25 carbon atoms, aralkylidynes having from 6 to 18 carbon atoms, aralkylylidynes having from 6 to 18 carbon atoms, and heterocycles, which are identical or different, having from 4 to 25 carbon atoms;
R₃ optionally comprises one or more identical or different heteroatom(s), chosen from O, N, S and Si;
m is equal to 1, 2 or 3;
n is equal to 1, 2 or 3,
in an amount between 0 and 7 mmol per 100 g of elastomer.

2. Rubber composition according to claim 1, wherein the polyamine compound is present in an amount preferably ranging from 1 to 6 mmol.

3. Rubber composition according to claim 1, wherein the natural rubber in the elastomeric matrix is present in a weight fraction of greater than or equal to 50% by weight of the total weight of the matrix.

4. Rubber composition according to claim 3, wherein the elastomeric matrix consists of 100% natural rubber.

5. Rubber composition according to claim 1, wherein the reinforcing filler comprises an organic filler in a proportion of 100% by weight of the total weight of the composition.

6. Rubber composition according to claim 1, wherein the reinforcing filler comprises an inorganic filler and further comprising a coupling agent.

7. Rubber composition according to claim 1, wherein the reinforcing filler comprises a reinforcing inorganic filler in proportions ranging from 55% to 100% by weight of the total weight of the composition.

8. Rubber composition according to claim 1, wherein the polyamine compound having at least two primary amine functions is chosen from the group consisting of diamines, triamines and tetraamines.

9. Rubber composition according to claim 8, wherein the polyamine compound having at least two primary amine functions is chosen from the group consisting of 1,6-hexamethylenediamine, 1,8-octamethylenediamine, 1,4-diaminocyclohexane, 1,2-diaminocyclohexane, N,N-bis(2-aminoethyl)ethane-1,2-diamine.

10. Process for the preparation of a reinforced rubber composition as described in claim 1, comprising:
(i) carrying out, at a maximum temperature of between 130° C. and 200° C., a first step of thermomechanical working of the necessary base constituents of the rubber composition, with the exception of the crosslinking system, by intimately incorporating, by kneading, ingredients of the composition in the elastomeric matrix based on natural rubber, then
(ii) carrying out, at a temperature lower than said maximum temperature of said first step, preferably of less than 110° C., a second step of mechanical working during which said crosslinking system is incorporated,
wherein, prior to carrying out the abovementioned stage (i), the process comprises the stages of the manufacture of natural rubber comprising a stage of addition of the primary polyamine compound corresponding to formula 1 or 2.

11. Process for the preparation of a reinforced rubber composition as described in claim 1, comprising:
(i) carrying out, at a maximum temperature of between 130° C. and 200° C., a first step of thermomechanical working of the necessary base constituents of the rubber composition, with the exception of the crosslinking system, by intimately incorporating, by kneading, ingredients of the composition in the elastomeric matrix based on natural rubber, then
(ii) carrying out, at a temperature lower than said maximum temperature of said first step, preferably of less than 110° C., a second step of mechanical working during which said crosslinking system is incorporated,
wherein, prior to carrying out the abovementioned stage (i), the process comprises a stage of preparation of a masterbatch based on non-halogenated natural rubber and on the primary polyamine compound.

12. Process for the preparation of a reinforced rubber composition as described in claim 1, comprising:
(i) carrying out, at a maximum temperature of between 130° C. and 200° C., a first step of thermomechanical working of the necessary base constituents of the rubber composition, with the exception of the crosslinking system, by intimately incorporating, by kneading, ingredients of the composition in the elastomeric matrix based on natural rubber, then
(ii) carrying out, at a temperature lower than said maximum temperature of said first step, preferably of less than 110° C., a second step of mechanical working during which said crosslinking system is incorporated,
wherein the primary polyamine compound is added directly during stage (i) with the other compounds of the composition.

13. Process for the preparation of a tire component according to claim 10, wherein the primary polyamine compound is added in a small proportion of between 0 and 7 mmol per 100 g of elastomer.

14. Tire semi-finished rubber product, comprising a crosslinkable or crosslinked rubber composition according to claim 1.

15. Tire, comprising a semi-finished product according to claim 14.

16. Rubber composition according to claim 5, wherein the organic filler comprises carbon black.

17. Rubber composition according to claim 6, wherein the inorganic filler comprises a reinforcing silica.
